(19) United States
(12) Patent Application Publication
(10) Pub. No.: US 2014/0032039 A1
(43) Pub. Date: Jan. 30, 2014

(54) Method and Apparatus for Periodic Onboard Compliance Testing

(71) Applicants: Patrick Joseph Dwan, Canton, MI (US); Henry Thomas Ubik, Grosse Pointe Park, MI (US); Paul Taberham, Chelmsford (GB)

(72) Inventors: Patrick Joseph Dwan, Canton, MI (US); Henry Thomas Ubik, Grosse Pointe Park, MI (US); Paul Taberham, Chelmsford (GB)

(73) Assignee: FORD GLOBAL TECHNOLOGIES, LLC, Dearborn, MI (US)

(21) Appl. No.: 13/558,804

(22) Filed: Jul. 26, 2012

(51) Int. Cl. G06F 7/00

(52) U.S. Cl. 701/33.4

(57) ABSTRACT

A system includes a processor and one or more vehicle systems, having a component in which errors can be diagnosed through electronic analysis. Also, the processor is configured to obtain instructions for running a vehicle diagnostic test, corresponding to government mandated testing, on the one or more vehicle systems, responsive to a user request. The processor is further configured to execute the test to obtain results. Also the processor was configured to log the results and report the results to a user

### TECHNICAL FIELD

The illustrative embodiments generally relate to methods and apparatus for periodic onboard compliance testing.

### BACKGROUND

On-Board Diagnostic (OBD) systems have existed in vehicles for over a decade. Equipped to monitor various vehicle systems and functions, these diagnostics can detect problems in a vehicle and save corresponding error information for later retrieval by a technician. Unfortunately, shifting/new standards in testing mean that these systems are not always up to date on the latest tests. Also, compliance standards can vary for different vehicles based on vehicle age, systems, etc.

U.S. patent application No. 12/476,995 generally describes a system and method for testing vehicle emissions and engine control components using a standalone self-service kiosk. The self-service kiosk includes a computer capable of gathering Vehicle Information (VIN) and OBD information from a vehicle being tested. using a barcode reader and an OBD reader, respectively. The self-service kiosk generates a readable display or printed report to the user indicating any detected diagnostic trouble codes found. during the vehicle emissions testing. By networking a plurality of self-service kiosks together in a secure network and accessible through the Internet, the self-service kiosk network maintains a centrally located vehicle information database for storing and retrieving pertinent vehicle-related information during vehicle emissions testing. If the vehicle being tested passes the vehicle emissions testing, then the self-service kiosk prints out a registration renewal sticker, registration renewal document and/or receipt for the user.

In a similar endeavor, U.S. patent application No. 10/545,513 describes A method and apparatus for on board diagnostics for a system, comprising carrying out one or more diagnostic steps with respect to one or more functions of the system. An electronic horizon system, which provides information relating to prospective system-influencing factors, is used to determine the optimum conditions in which to carry out at least one of the diagnostic steps.

Another onboard diagnostic patent application is 11/1535,464, describing a method and apparatus for testing vehicle emissions and engine control components using a self-service on-board diagnostics (OBD) kiosk. A stand-alone kiosk includes a computing device capable of gathering VIN information and OBD information from a vehicle using a VIN reader and OBD reader, The kiosk generates a readable display or printed, report for the kiosk operator indicating any detected diagnostic trouble codes found during the OBD test. By networking a plurality of kiosks together in a secure network and accessible to the Internet, an OBD kiosk network maintains a. centrally located vehicle interface database for storing and retrieving pertinent vehicle-related information during OBD testing.

### SUMMARY

In a first illustrative embodiment, a system includes a processor and one or more vehicle systems, having a component in which errors can be diagnosed through electronic analysis. Also, the processor is configured to obtain instructions for running a vehicle diagnostic test, corresponding to government mandated testing, on the one or more vehicle systems, responsive to a user request. The processor is further configured to execute the test to obtain results. Also the processor was configured to log the results and report the results to a user.

In the second embodiment, a computer-implemented method includes obtaining instructions for running a vehicle diagnostic test, via a vehicle computing system. The instructions correspond to government mandated testing, on one or more vehicle systems, having a component in which errors can be diagnosed through electronic analysis. The illustrative method also includes executing the test to obtain results. Also, the method includes loggin the results and reporting the results to a user.

In a third illustrative embodiment, a system includes a processor, configured to communicate with a remote vehicle computing system (VCS). The processor is configured to receive a request for one or more test instructions from the VCS. The processor is configured to receive a VIN identifying the vehicle in which the VCS resides. The processor is also configured to access a database to obtain at least one test corresponding to a government required test. Further, the process is configured to customize the test for the vehicle based on a vehicle configuration as defined by the VIN. Also, the processor is configured to deliver the customized test instructions to the VCS.

### BRIEF DESCRIPTION OF THE DRAWINGS

FIG. 1 shows an illustrative example of a vehicle computing system;

FIG. 2 shows an exemplary process for running a diagnostic;

FIG. 3 shows an exemplary process for an external diagnostic;

FIG. 4 shows a second exemplary process for an external diagnostic; and

FIG. 5 shows an exemplary process for failure handling.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

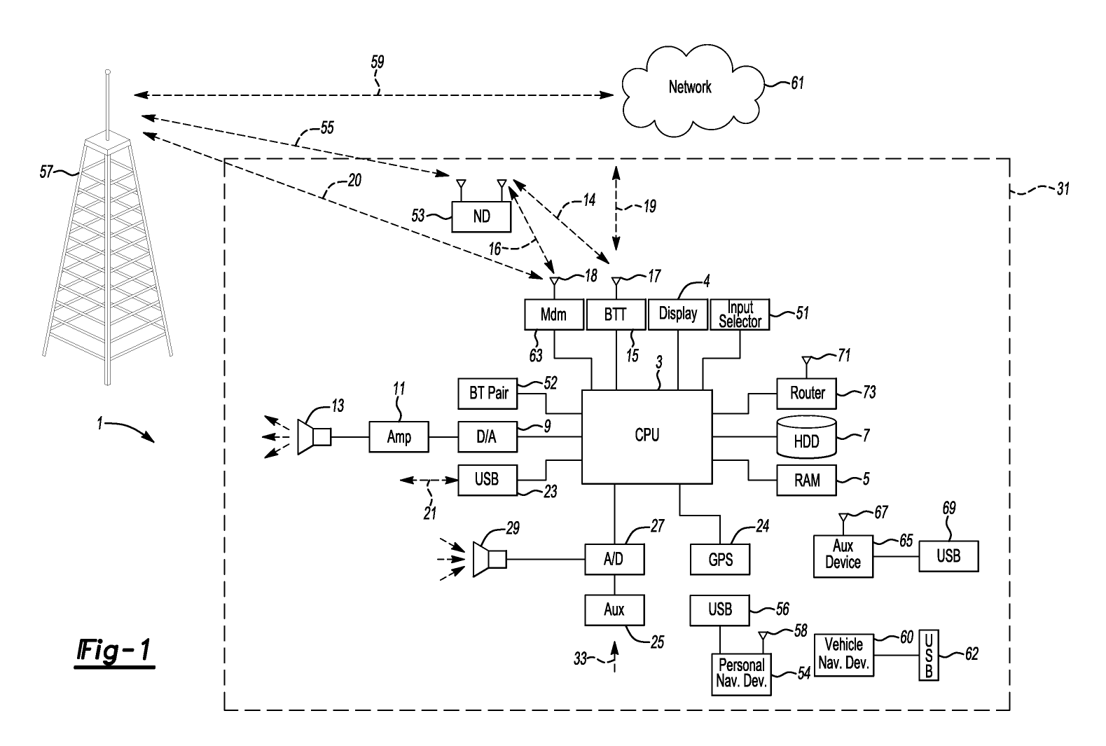

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™(Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

For years there have been varying standards and tests that many automobiles have had to pass before registration can be issued for a new year. For example, without limitation, emissions testing, light functionality verification, and numerous other “standards” may have to be met before a vehicle can be certified for use on the road. As vehicles age, these tests become important to ensure that unsafe vehicles are not certified for travel on the streets.

In some other instances, these tests are performed at time of transfer of ownership, but, whatever the reason, the tests typically require some expenditure of money to have a certified mechanic or dealer perform the test. If the test is passed, then the driver can continue with whatever procedure mandated the test. If the test is failed, however, the driver then has to have the problem that caused the failure rectified, and has then both lost the money spent on the test and the time involved in traveling to, waiting for and having the test performed.

As on-board diagnostic tools become more sophisticated, the testing may require additional use of these tools. Further, vehicle electronic systems are capable of detecting a variety of failures, due to the computer-based nature of many vehicle modules. In order to address the situation where an owner may want to avoid having to double up on the time and cost of testing, the illustrative embodiments provide some examples of diagnostic reports that can be produced for a vehicle user prior to travel to a testing center.

Further, the standards of testing may vary year to year, may change over time, or may be dependent on a vehicle age. Since the VCS performing the test data gathering can also access remote servers, updated and appropriately formatted versions of the test can be obtained for each vehicle on an individual basis, depending on the needs of that particular vehicle.

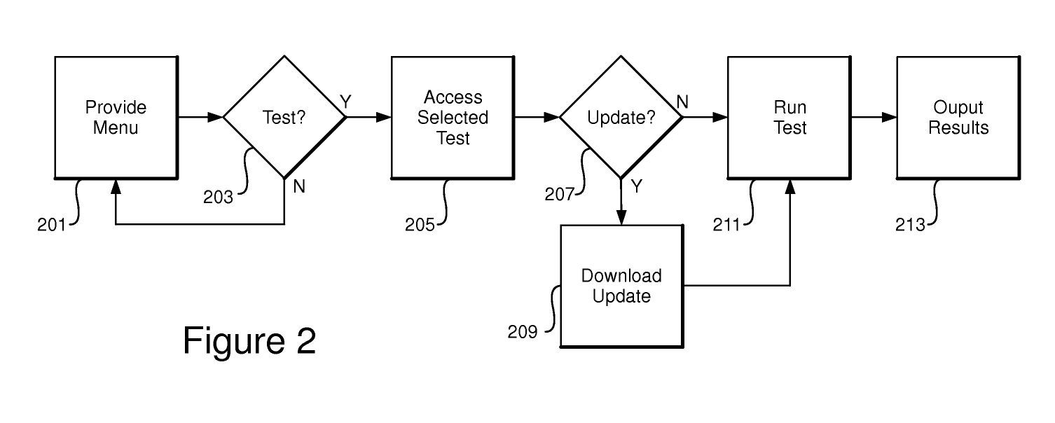

FIG. 2 shows an exemplary process for running a diagnostic. In this example, the vehicle provides an option wherein the user can specifically request one or more diagnostic tests. In another instance, the tests may be run periodically and results can be stored or output to the user (especially in the event of an alert condition). It may be useful to have on-demand diagnostics even if the tests are automatically run, so that a user can perform the tests just prior to any regulatorily mandated testing.

In this illustrative example, the process provides a menu listing all diagnostic tests available 201. The menu can also list other services, such as, for example, “update tests,” “show recent results,” etc. In another example, there may only be an option to run a test, and results for all possible diagnostics can be obtained and delivered to the user (e.g., output to the vehicle, emailed, SMS messaged, etc.).

If a test is selected from the menu 203, in this example, the process can then access the selected test. Some exemplary tests include, but are not limited to, Electronic Fitment Tests, Exterior Light Tests, Vehicle Health Status, etc. Certain tests, such as, for example, emissions tests, may not be able to be performed without the use of a tool to measure and evaluate emission gas. On the other hand, the above tests will typically be performed by a dealer/mechanic who inserts a diagnostic tool into a vehicle ODB. Since the tests typically involve the vehicle's electronic systems, the process can typically determine at least some degree of fault existence through processing internal code on a vehicle computing system.

Once a particular test is selected, a vehicle VIN may be uploaded to a remote server, along with any other information, to see if an updated version of a currently stored test is needed 207. For example, a vehicle brake light test may, in years 1-2 of a vehicle's life, only require testing of brake lights. In years 3-5, hazards and turn signals may be added to the test. In years 5+, all lighting systems may have to be tested. This example is simply provided as an illustration of how a test requirement may change with time or as a vehicle ages, and is not intended to restrict the invention in any manner.

If an update is required, the process may download the appropriate version of a test for the particular vehicle identified by the VIN 209. Since different vehicle's may have different interior electronic configurations, different tests can be made available for different models, as identified by a VIN. In this manner, the vehicle computing system can replicate, as closely as possible, the testing that will occur when the mandated test takes place.

As soon as a suitable version of the test is obtained by the VCS, the process may run that test on the vehicle 211. All relevant features, as defined by the test, can be tested and passes/failures can be logged for reporting to a user and dealer/mechanic retrieval. The results of the test, whether positive or negative, can be output to a user 213 and/or delivered to the user in any number of other forms (email, text, etc).

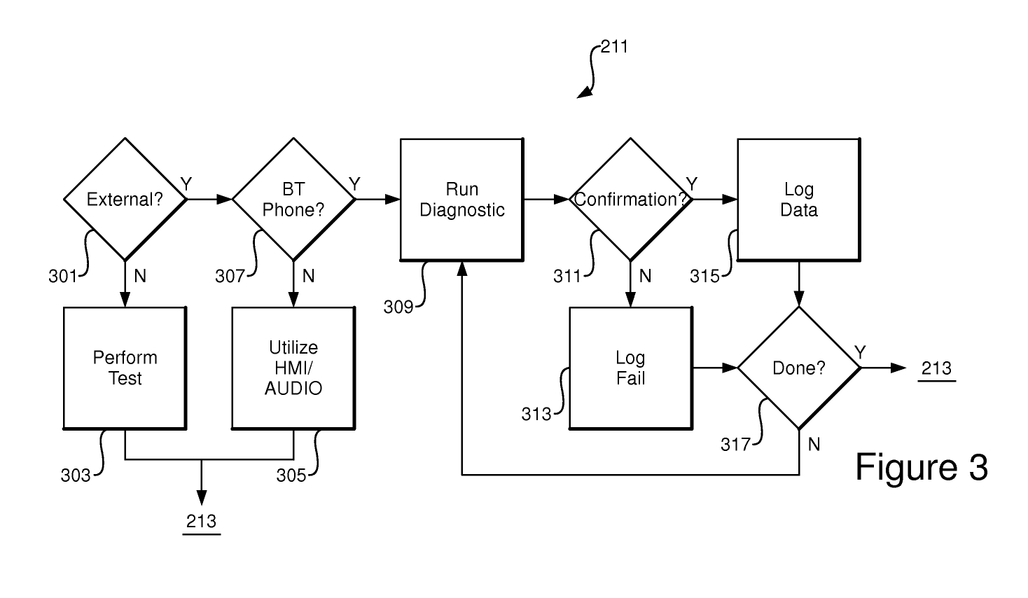

FIG. 3 shows an exemplary process for an external diagnostic. In this illustrative embodiment, the test may require an observation of an external system. Warning signals and lights may indicate a potential failure with an exterior lighting system, but visual inspection may be required to determine the specific problem (or whether a problem actually exists).

In this example, the owner will perform a visual inspection of the vehicle, responding to queries from the vehicle as various lighting systems are engaged by the vehicle. First, the process determines if an external test is going to take place 301. If not, the process will proceed with an internal system diagnostic 303, which will typically not involve owner interaction.

If the exterior test is going to take place, an application may be placed on or running on a connected Bluetooth (BT) device. If a BT device is not present 307, the system may attempt to run the test utilizing an interior HMI and/or exterior vehicle speakers that may be equipped to output audio commands to a user 305.

If there is a BT device present, and if a compatible application is running on the device, the process may proceed to walk the user through a series of tests that will allow the user to visually verify the operability of various vehicle lighting systems 309. For example, a phone display may display “Press the key below to begin brake light testing.”

Once a user presses the appropriate input, the process can perform a series of brake light tests. For example, the process could illuminate a left brake light and display “illuminating brake lights. Do you see a light?” The process could also then display “yes” and “no” inputs so the user could verify the functionality of the various lights 311. This same process could continue for headlights, fog lights, high beams, turn signals, etc. Further, since some users may be unfamiliar with which lights, specifically, are being examined, the process could visually display an example of both the lights that a user should be looking at and possibly an animated change showing the change a user should be looking for (e.g., the switch from regular lights to high-beams).

As the user progresses through the test, responses to questions from the testing process are input into the wireless device, and the results are stored as the diagnostic test results. These results can then be compiled into a report to be presented to the user. Any failures will have been observed by the user and can further be retrievable through use of the test results. User input can be stored, in many cases, as affirmative input 315 and negative input 313. The test can then check to see if the user has requested premature ending of the test, or if all the reasonable tests have been performed 317. Once all suitable tests have been performed, the process can continue to a reporting mode 213.

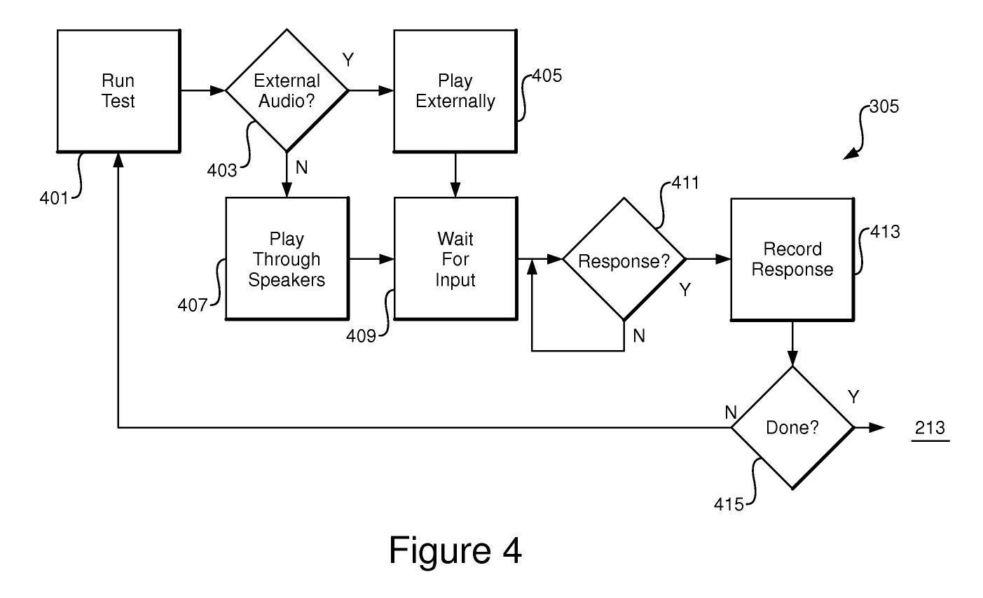

FIG. 4 shows a second exemplary process for an external diagnostic. In this illustrative example, the process is an external diagnostic process, such as, for example, a brake light examination process. In this example, however, there may not be a compatible phone available for which an input application can be connected and/or run. In such a case, a vehicle audio system may be used, including, for example, external speakers if available. If external speakers are not available, a user may be instructed to lower one or more windows and turn up an internal volume to a level where test instructions can be heard.

In this illustrative example, the process begins running the appropriate test 401. As before, the process may, for example, be testing vehicle lights and may first activate, for example, brake lights. Since the user will need to know which lights to examine, the process may check to see if there are external outputs available 405. These could be special speakers installed for the purposes of this test, or speakers that serve a multitude of purposes, such as, for example, playing alarms, warnings and other information.

If there are not external speakers available, the process may have instructed a user to roll down windows while the test is performed. In this case, the internal speakers will be used to provide the user with instructions as to which lights to view. As various lights are tested, instructions will be output through the internal speakers 407.

Once a particular test has been run, in this example, a user may input the result before the test proceeds 411. Accordingly, the process may wait until a response to a particular test query has been input before proceeding to the next test step. Once a response as to the functionality of the tested portion has been input, the process may proceed to record the response 413. The process may then check to see if all testing is completed or not 415. If more testing remains, the process may run a next step of the test 401, and the according following steps.

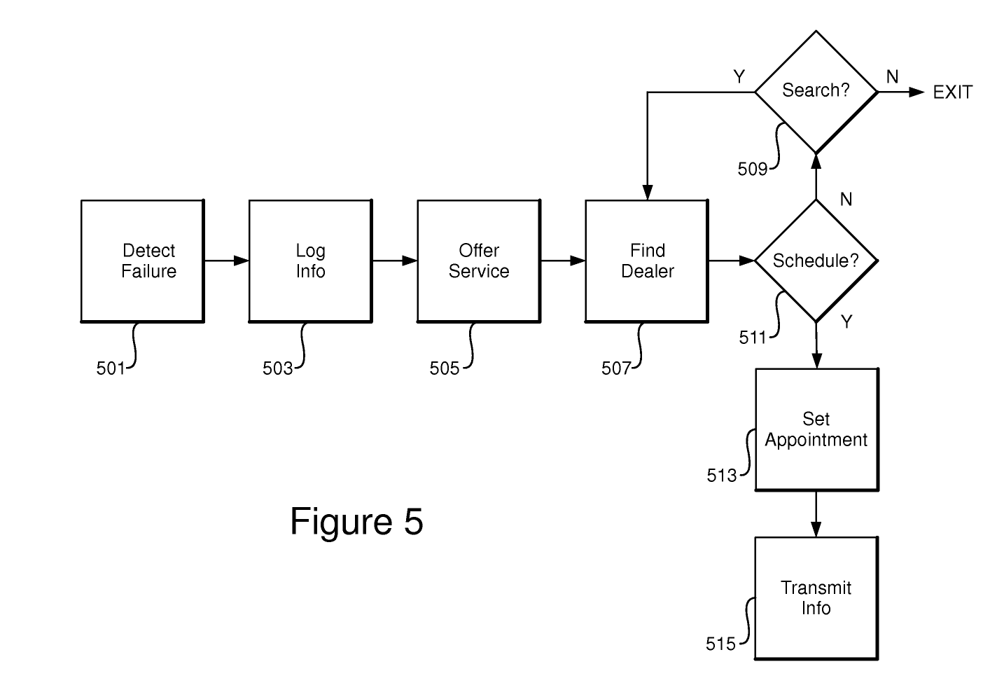

FIG. 5 shows an exemplary process for failure handling. In this example, the process detects a failure associated with one or more aspects of a diagnostic test 501. Since the diagnostic test will likely need to be passed before a vehicle can be certified, the failure may be something a driver wants to have rectified. In addition, the diagnostic tests usually relate to safety-oriented systems, and so the user may want to have the failure corrected for their own safety.

Once a failure has been detected, the process will log information relating to the failure 503 so that the information can be later retrieved by both a user and/or a mechanic/dealer who is servicing the vehicle. Once the information has been logged, the process may determine one or more local dealerships that can provide servicing relating to the discovered error, and offer the user with an option to schedule servicing 505.

If the user elects to schedule servicing, the process may find a convenient dealership (or user selected mechanic, for example) 507. This could be a dealership located on a route to work, near work or near a user's home. The relevant travel information to make this determination may be stored in a vehicle system.

If a dealer is found, and the user wishes to schedule an appointment, the process may proceed to work with the user and a dealer computer system to schedule an appointment 513. The appointment may then also be stored in a vehicle calendar application, so it can be provided to a user on-demand, and the user can be reminded when the relevant date approaches.

Also, in conjunction with scheduling the appointment, relevant diagnostic information relating to the test results and/or the system failure can be transmitted to the dealer, in case, for example, any parts need to be ordered 515.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor; and
one or more vehicle systems, having a component in which errors can be diagnosed through electronic analysis, wherein
the processor is configured to obtain instructions for running a vehicle diagnostic test, corresponding to government mandated testing, on the one or more vehicle systems, responsive to a user request,
execute the test to obtain results,
log the results, and
report the results to a user.

2. The system of claim 1, wherein the test is a vehicle fitment test.

3. The system of claim 1, wherein the test is vehicle health status test.

4. The system of claim 1, wherein the test is a vehicle exterior light test.

5. The system of claim 4, wherein the processor is further configured to communicate with a wireless device for providing instructions on light examination and to receive responses to tests of various exterior light systems.

6. The system of claim 4, wherein the processor is configured to output instructions on light examination through a vehicle audio system and to receive responses to tests of various exterior light systems input into a vehicle computing system input.

7. The system of claim 6, wherein the vehicle audio system includes exterior speakers.

8. The system of claim 1, wherein the test is tailored to a vehicle based on a vehicle VIN and current government standards required for that test in a vehicle having characteristics identified by the VIN.

9. A computer-implemented method comprising:
obtaining instructions for running a vehicle diagnostic test, via a vehicle computing system, corresponding to government mandated testing, on one or more vehicle systems, having a component in which errors can be diagnosed through electronic analysis,
executing the test to obtain results;
log the results; and
report the results to a user.

10. The method of claim 9, wherein the test is a vehicle fitment test.

11. The method of claim 9, wherein the test is vehicle health status test.

12. The method of claim 9, wherein the test is a vehicle exterior light test.

13. The method of claim 12, wherein the method includes:
communicating with a wireless device for providing instructions on light examination; and
receiving responses to tests of various exterior light systems.

14. The method of claim 12, wherein the method includes:
outputting instructions on light examination through a vehicle audio system; and
receiving responses to tests of various exterior light systems input into a vehicle computing system input.

15. The method of claim 9, wherein the test is tailored to a vehicle based on a vehicle VIN and current government standards required for that test in a vehicle having characteristics identified by the VIN.

16. A system comprising:
a processor, configured to communicate with a remote vehicle computing system (VCS),
to receive a request for one or more test instructions from the VCS,
to receive a VIN identifying the vehicle in which the VCS resides,
to access a database to obtain at least one test corresponding to a government required test,
to customize the test instructions for the vehicle based on a vehicle configuration as defined by the VIN, and
to deliver the customized test instructions to the VCS.

17. The system of claim 16, wherein the test is a vehicle fitment test.

18. The system of claim 16, wherein the test is vehicle health status test.

19. The system of claim 16, wherein the test is a vehicle exterior light test.

20. The system of claim 19, wherein the processor is further configured to communicate with a wireless device for providing instructions on light examination and to receive responses to tests of various exterior light systems.
